(19) United States
(12) Patent Application Publication
(10) Pub. No.: US 2013/0101098 A1
(43) Pub. Date: Apr. 25, 2013

(54) Interaction With a Device via a Communications Network

(71) Applicants: Oscar Novo Diaz, Helsinki (FI); Jari Arkko, Kauniainen (FI); Heidi-Maria Rissanen, Helsinki (FI)

(72) Inventors: Oscar Novo Diaz, Helsinki (FI); Jari Arkko, Kauniainen (FI); Heidi-Maria Rissanen, Helsinki (FI)

(21) Appl. No.: 13/409,405

(22) Filed: Mar. 1, 2012

Related U.S. Application Data
(60) Provisional application No. 61/550,812, filed on Oct. 24, 2011.

(51) Int. Cl. H04M 11/00

(52) U.S. Cl. 379/93.01

(57) ABSTRACT

A gateway apparatus enables interaction with a device that is connected to a network. The gateway receives voice or Dual-Tone Multi-Frequency (DTMF) signals from a user terminal via a circuit-switched connection. The received voice or DTMF signals are used in conjunction with a semantic data document to ascertain an interaction to be carried on with the device. Signals are generated and received via the network in accordance with the ascertained interaction. A user friendly response from the interaction can be formed (e.g., in the form of a voice response) and communicated to the user terminal via the circuit-switched connection.

### CROSS REFERENCE TO RELATED APPLICATIONS

This application claims the benefit of U.S. Provisional Application No. 61/550,812, filed Oct. 24, 2011, which is hereby incorporated herein by reference in its entirety.

### BACKGROUND

The present invention relates to the provision of data through a communications network in response to a request.

Interactive voice response (IVR) is a technology that allows some sort of processing means, such as a computer, to interact with callers through the use of voice and/or Dual Tone Multi-Frequency (DTMF) keypad inputs. IVR technology enables callers to retrieve and gather information including but not limited to bank balances, flight schedules, product details and weather forecasts. In some instances, IVR technology also allows a user to invoke an action, such as but not limited to tele-voting. In typical embodiments, a user employs a communication device (e.g., a telephone of some sort) to establish a connection with the automated system, which then generates one or more automated audible prompts that the user can hear. In response to the prompt, the user either speaks into a microphone of his/her device or alternatively presses one of the device's keys to provide the system with more information about what exactly is being requested.

Such systems have conventionally been employed to allow a user to interact with fully capable processing entities over mid- to high bandwidth communication networks. But recently, constrained networks equipped with different sensors and actuators have been gaining attention among researchers. The fields of their possible applications range from intelligent housing to precision agriculture.

As the name suggests, the devices that make up a constrained network have any of a number of constraints imposed on them, such as but not limited to constraints on size and cost. These constraints in turn translate into design limitations on, for example, energy consumption (e.g., a battery powered device that is expected to be left in place for an extended period of time needs to use energy prudently), memory capacity, computational speed, and communication bandwidth.

Such devices cannot be expected to support any of today's typical full communications network protocols. To accommodate these various limitations, special low overhead protocols such as the Constrained Application Protocol (CoAP) have been developed. The interested reader can learn more about CoAP in Z. Shelby et al., “Constrained Application Protocol (CoAP) draft-ietf-core-coap-08”, CoRE Working Group, Internet-Draft, Nov. 1, 2011, which is hereby incorporated herein by reference in its entirety. The simplicity and low overhead required by such protocols allows constrained resource devices to communicate with other entities.

Allowing such devices to communicate with other machines is useful. For example, having a room's temperature constantly monitored by a remotely situated apparatus that can automatically invoke some action in response to a detection that the temperature has crossed a threshold value can offer many advantages.

There are also circumstances when it would be desirable to allow remote human interaction with constrained devices to receive information from them and/or to control them. However, the inventors of the subject matter described herein have found that many solutions to the problem of remote human/machine interaction impose requirements that exceed the constraints of the devices. For example, it cannot be expected that processing/memory-constrained devices will be able to support program specific applications needed to allow an IVR interface. The convenience and feasibility of human interaction with these constrained networks raises a need for solutions that offer humans the flexibility of communicating and interacting with all sorts of devices spanning a wide range of capabilities.

### SUMMARY

It should be emphasized that the terms “comprises” and “comprising”, when used in this specification, are taken to specify the presence of stated features, integers, steps or components; but the use of these terms does not preclude the presence or addition of one or more other features, integers, steps, components or groups thereof.

In accordance with one aspect of the present invention, the foregoing and other objects are achieved in, for example, methods and apparatuses for operating a gateway apparatus to interact with a device that is connected to a network. Such operation includes receiving voice or Dual-Tone Multi-Frequency (DTMF) signals from a user terminal via a circuit-switched connection. The received voice or DTMF signals are used in conjunction with a semantic data document to ascertain an interaction to be carried on with the device. Signals are then generated and received via the network in accordance with the ascertained interaction.

In an aspect of some but not necessarily all embodiments, one or more signals received from the device are used in conjunction with the semantic data document to generate a response to be sent to the user terminal via the circuit-switched connection. In some but not necessarily all of such embodiments, the response to be sent to the user is formed as a voice response.

In an aspect of some but not necessarily all embodiments, the semantic data document is an Extensible Markup Language (XML) document.

In an aspect of some but not necessarily all embodiments, the network is a constrained network.

In an aspect of some but not necessarily all embodiments, operation includes retrieving the semantic data document from a memory that is part of the gateway apparatus.

In an aspect of some but not necessarily all alternative embodiments, operation includes retrieving the semantic data document from a memory that is external to the gateway apparatus. As a non-limiting example, the memory that is external to the gateway apparatus is, in some embodiments, part of the device.

In an aspect of some but not necessarily all embodiments, the semantic data document separately defines permissible interactions for each one of a plurality of devices.

In an aspect of some but not necessarily all embodiments, the semantic data document defines an address of the device on the network.

### BRIEF DESCRIPTION OF THE DRAWINGS

FIG. 1 is a block diagram of an exemplary embodiment of an automated system that is consistent with aspects of the invention.

FIG. 2 is, in one respect, a flow chart of steps/processes performed by a gateway in accordance with some but not necessarily all exemplary embodiments of the invention.

FIG. 3 is a block diagram of an exemplary embodiment of a gateway that is consistent with one or more aspects of the invention.

FIG. 4 is a block diagram of an exemplary gateway implemented primarily from programmable circuitry.

### DETAILED DESCRIPTION

The various features of the invention will now be described with reference to the figures, in which like parts are identified with the same reference characters.

The various aspects of the invention will now be described in greater detail in connection with a number of exemplary embodiments. To facilitate an understanding of the invention, many aspects of the invention are described in terms of sequences of actions to be performed by elements of a computer system or other hardware capable of executing programmed instructions. It will be recognized that in each of the embodiments, the various actions could be performed by specialized circuits (e.g., analog and/or discrete logic gates interconnected to perform a specialized function), by one or more processors programmed with a suitable set of instructions, or by a combination of both. The term “circuitry configured to” perform one or more described actions is used herein to refer to any such embodiment (i.e., one or more specialized circuits and/or one or more programmed processors). Moreover, the invention can additionally be considered to be embodied entirely within any form of computer readable carrier, such as solid-state memory, magnetic disk, or optical disk containing an appropriate set of computer instructions that would cause a processor to carry out the techniques described herein. Thus, the various aspects of the invention may be embodied in many different forms, and all such forms are contemplated to be within the scope of the invention. For each of the various aspects of the invention, any such form of embodiments as described above may be referred to herein as “logic configured to” perform a described action, or alternatively as “logic that” performs a described action.

Aspects of the invention provide mechanisms whereby remote users can employ IVR technology to access all sorts of devices including but not limited to constrained devices. An aspect of embodiments consistent with the invention involves a mechanism whereby a remote user can access IVR technology by means of a circuit switched connection. Using an application specific dialog, the user responds to prompts and/or otherwise indicates his/her directives by means of voice and/or invoking DTMF signaling.

In another aspect of some embodiments consistent with the invention, the mechanism comprises a gateway arranged to interact towards the remote user over the circuit switched connection and towards a device via a network. The device can but is not required to be any type of constrained device such as, but not limited to, a sensor or actuator. In such cases, the network is advantageously configured as a constrained network. The gateway is further arranged to translate information received over the circuit switched connection into a suitable form for use towards the (constrained) network and/or vice versa. Information returned to the gateway by the device is then converted by the IVR technology into a suitable form for presentation to the remote user via the circuit switched network.

The translation of the information received over the circuit switched connection into a suitable form for use towards the device is facilitated by means of a semantic document. (As used herein, the term “document” is not intended to refer to stand-alone paper documents whose target audience consists of human beings, but rather to an arrangement of data stored in a non-transitory processor-readable medium, such as but not limited to electronic, magnetic, and optical storage media.)

The semantic document includes device data that, for each device that the gateway can connect to, defines, in some respects, how to interact with that device. In addition, the semantic document includes semantic data that informs what the device data really is.

These and other aspects are further described in the following.

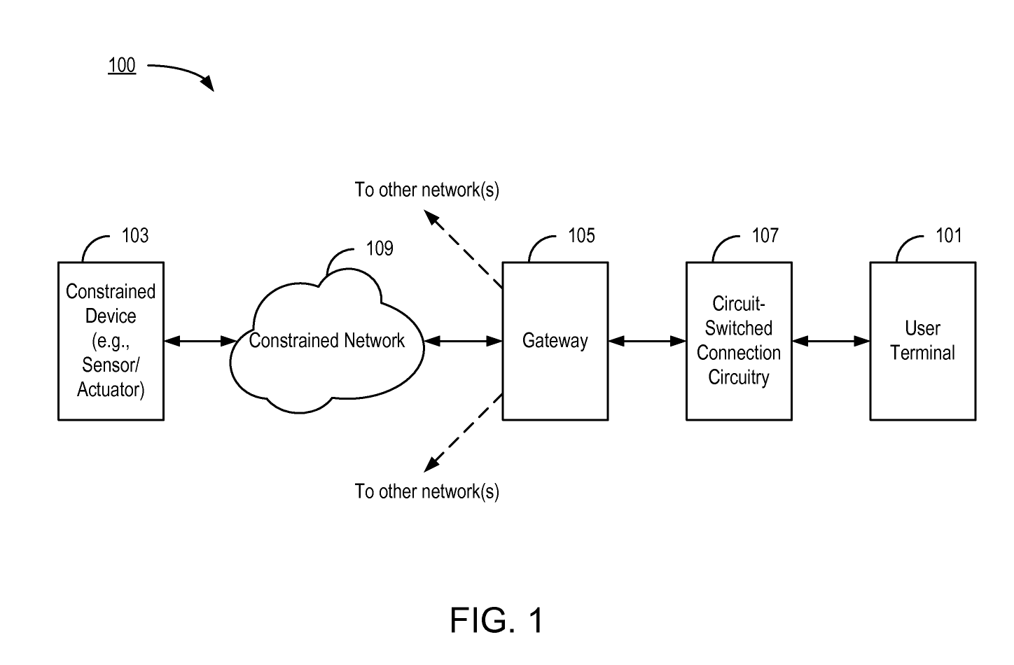

FIG. 1 is a block diagram of an exemplary embodiment of an automated system 100 that is consistent with aspects of the invention. A user terminal 101 illustrates the means by which a remote user will be able to interact with one or more devices. The user terminal 101 can be any type of communication device including but not limited to traditional landline telephones, mobile telephone equipment, and other types of equipment capable of establishing a circuit-switched connection over established networks. The user's interaction can include, for example, listening to prompts reproduced by a loudspeaker of the user terminal 101, speaking into a microphone of the user terminal, and/or depressing one or more keys of the user terminal that cause DTMF tones to be generated and conveyed along the circuit-switched connection.

In this example, it is assumed that the user wishes to interact with a constrained device 103, such as but not limited to a sensor or actuator. It will be seen that embodiments of the invention permit interaction with all sorts of devices including those that are not constrained.

An important component of the system 101 is a gateway 105 that mediates interactions between the user terminal 101 and the constrained device 103. The gateway 105 is communicatively coupled to the user terminal 101 by means of circuit-switched connection circuitry 107. In practice, the remote user may establish the circuit-switched connection by dialing a telephone number associated with the gateway. Alternatively, the telephone number can be associated with the device 103 with which the remote user wishes to interact.

The gateway's connection to the desired device may depend on the device type. In the case of the illustrated constrained device 103, the gateway is communicatively coupled to the constrained device 103 by means of a constrained network 109. The gateway 105 may employ, for example, any suitable communication protocol for communicating with constrained devices including but not limited to CoAP and HyperText Transfer Protocol (HTTP). The interested reader can learn more about HTTP in D. Raggett et. al., eds. “HTML 4.01 Specification”, W3C Recommendation 24 Dec. 1999. The gateway 105 may also communicate with other devices, including those that are not considered to be constrained. For this purpose, the gateway may have the ability to establish connections with such devices by means of one or more other networks (illustrated in the FIG. 1 by the dashed lines).

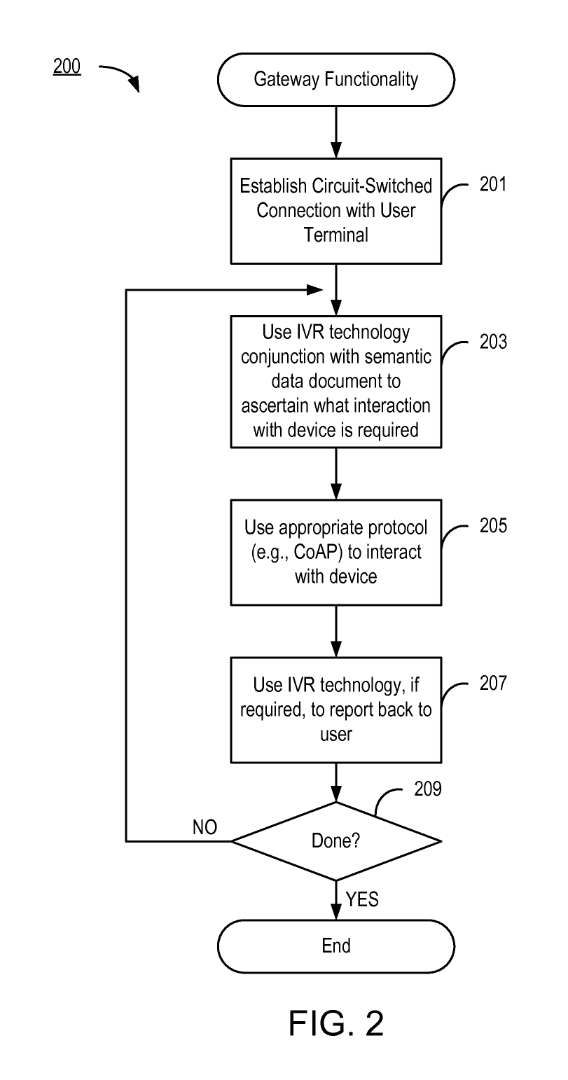

FIG. 2 is, in one respect, a flow chart of steps/processes performed by a gateway 105 in accordance with some but not necessarily all exemplary embodiments of the invention. In another respect, FIG. 2 can be considered to depict exemplary means 200 comprising the various illustrated circuitry (e.g., hard-wired and/or suitably programmed processor) configured to perform the described functions.

In this example, a circuit-switched connection with the user terminal 101 is established (step 201). This can, for example, be a result of the remote user operating the user terminal 101 to dial a telephone number associated with either the gateway 105 or with the device 103. If the gateway 105 is associated with more than one device and the telephone number is only generally associated with the gateway 105, the remote user's interactions may have to include indicating which device he/she wants to interact with.

Having established the circuit-switched connection with the user terminal 101, the gateway's IVR technology interacts with the remote user in order to ascertain what interaction with the device 103 is required (step 203). The interactions may include one or more of the following:
providing voice prompts to the user to elicit a voice or DTMF response
receiving a voice or DTMF response
ascertaining whether further prompting and receiving is necessary to ascertain exactly what interaction with the device will be required (and possibly also to establish which device out of several is to be interacted with)

It will be appreciated that in carrying out this interaction, the gateway relies on a semantic data document that has been obtained either locally (i.e., within the gateway 105) or from an external source (not illustrated) in order to understand exactly what the remote user is requesting/indicating, and what sort of responses to return to the user.

Once the required interaction with the device is known, the gateway 105 uses a device-appropriate protocol to interact with the device 103 as necessary to carry out the remote user's wishes (step 205). If the device 103 has returned information that should be reported to the remote user, then IVR technology is used to convert this into a form that is easily understandable by the user (e.g., in the form of automated speech) and it is supplied to the user via the circuit-switched connection (step 207).

A check is next performed to ascertain whether any further interactions with the device are called for (decision block 209). In general, this check will be application specific, depending on the device involved and what sorts of options are available for presentation to the user. It is therefore beyond the scope of this description to provide any further detail other than to state that those of ordinary skill in the art will readily understand how to implement this particular functionality in the context of the application being designed.

If further interaction is called for (“NO” path out of decision block 209), then processing reverts back to step 203. Otherwise (“YES” path out of decision block 209), processing ends. The circuit switched connection can be torn down either by the remote user or by the gateway 105.

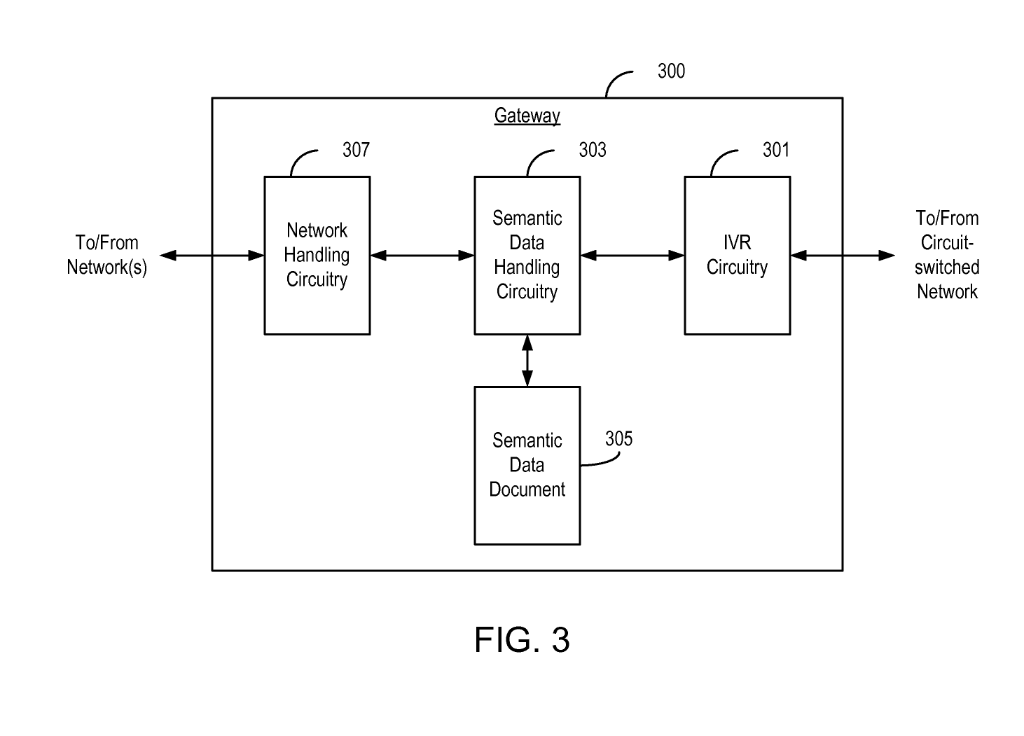

FIG. 3 is a block diagram of an exemplary embodiment of a gateway 300 that is consistent with one or more aspects of the invention. To facilitate the reader's understanding, various functions are depicted as being separately implemented. This is, in fact, one possible way of embodying such a gateway, either through separate dedicated circuitry for each function (e.g., an Application Specific Integrated Circuit for each function) or separately implemented processors each with suitable programming stored on a non-transitory computer-readable storage medium, or a combination of both. However, it will be understood that in practical embodiments, hardware and/or software components along with the one or more processors that run the software may be shared among any two or more of the indicated functions. For example, the gateway intelligence can be implemented in the form of a single processor configured to access and run one or more sets of program instructions that have been stored in a non-transitory computer-readable storage medium. Since even programmed processors are implemented by circuit elements, the general term “circuitry” is utilized herein to refer to any type of physical implementations, both programmable and hard-wired.

The gateway 300 operates in a manner consistent with the foregoing description, for example that which has been presented in connection with FIGS. 1 and 2. Accordingly, the gateway includes IVR circuitry 301 for coupling to a circuit-switched connection network. The IVR circuitry 301 enables the gateway 301 to interact with a remote user (operating a user terminal 101) in a manner that is convenient for the user (e.g., via the provision of voice prompts and the receipt of voice responses and or DTMF signaling).

The IVR circuitry 301 converts information received by the remote user into a form that is usable within the gateway. In particular, the user's information is supplied to semantic data handling circuitry 303. The semantic data handling circuitry 303 also has access to a semantic data document 305, which in some embodiments is stored locally as part of the gateway 300, and in other embodiments is stored elsewhere in a manner that makes it accessible to the gateway 300. For example, the semantic data document 305 could be defined in a distributed way among the various devices served by the gateway. Alternatively, the semantic data document 305 could be stored in a remote server. The semantic data document 305 should be constructed from a language that permits specification not only of data that is pertinent to the one or more devices with which the gateway 300 will interact, but also that allows the meaning of that data to be defined. For example, the semantic data document 305 can be written using the Extensible Markup Language (XML) schema. The interested reader can learn more about XML in Tim Bray et al., eds. “Extensible Markup Language (XML) 1.0 (Fifth Edition)”, W3C Recommendation, 26 Nov. 2008. Other languages that can be used as alternatives include, without limitation, Java Script Object Notation (JSON), YAML (a data serialization language), HyperText Markup Language (HTML), and Efficient XML Interchange (EXI).

The semantic data handling circuitry 303 uses the semantic data document 305 to make sense of the requests, directives and other information supplied by the remote user via the IVR circuitry 301. In some instances, the semantic data handling circuitry 303 may have to interact back-and-forth with the remote user to obtain complete information about what interaction is to be performed with respect to the device. In a non-limiting example, using voice commands, the remote user may first indicate what device he/she is talking about; next the remote user may indicate whether he/she wishes to control the device, or whether he/she wishes to obtain information from the device; finally, the remote user may specify exactly what controls or information are involved. Interspersed with the remote user's voice directives/information are prompts, by which the gateway 300 (acting through the IVR circuitry 301) informs the remote user what type of command or information to speak next. In this way, the gateway 300 can guide the remote user through a hierarchical menu of possible responses.

Once the gateway 300 knows which device is involved and what interaction is to be conducted with that device, the semantic data handling circuitry 303 supplies suitable information data and control signaling to network handling circuitry 307. The network handling circuitry 307 uses the information and control signaling to direct its operations in which it communicates with the designated device by means of a network to which the device is connected (e.g., a constrained network when the device is a constrained device). The network handling circuitry 307 carries out the desired interaction with the device, and then reports back to the semantic data handling circuitry 303. Standardized formats that can govern the form of the data exchanged with the device include, but are not limited to, HTML, XML, and JSON.

The semantic data handling circuitry 303 in turn uses the semantic data document 305 to make sense of the information received from the device, and responds by selecting an appropriate response to be supplied to the remote user. Information about the response is supplied to the IVR circuitry 301 so that the remote user can receive the response in a format that is convenient (e.g., by means of automated speech).

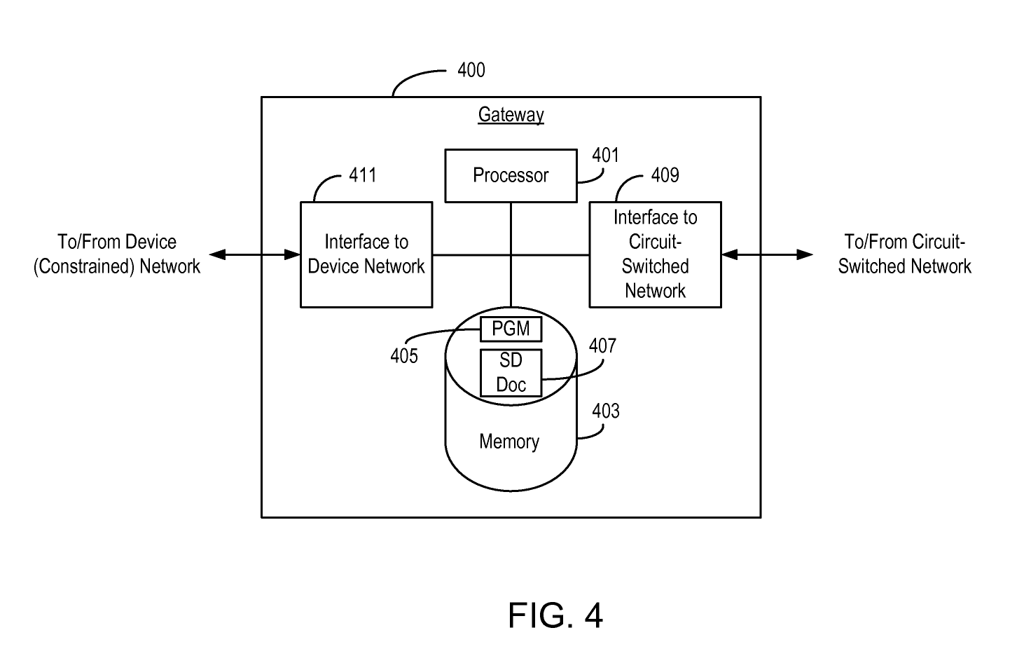

To further illustrate one category out of a number of possible categories of embodiments, FIG. 4 is a block diagram of an exemplary gateway 400 implemented primarily from programmable circuitry. The gateway 400 includes a processor 401 that is coupled to exchange data with a memory 403, which is a non-transitory storage medium. The memory 403 has stored therein a set of program instructions 405 that, when executed by the processor 401, cause the processor 401 to carry out functionality as described above, such as that which was described with respect to FIGS. 1, 2, and 3. In this exemplary embodiment, the memory 403 also stores a semantic data document (SD Doc) 407, although in alternative embodiments the semantic data document can be stored elsewhere as described earlier. The processor 401 is further coupled to interface circuitry 409 for exchanging data with a circuit-switched network, and also to interface circuitry 411 for interacting with the one or more devices via a network to which they are connected.

To further illustrate aspects of embodiments consistent with the invention, an exemplary semantic data document 305 will now be presented. To provide a non-limiting context for the example, the gateway 300 is assumed to be able to interact with several different kinds of devices, all of them being sensors of some type. However, neither the particular types of devices nor the information defined in the semantic data document 305 are essential aspects of the invention.

In this example, the semantic data document 305 is an XML document that defines the name, Internet Protocol (IP) address, class of the sensors, and the different IVR options of each of the sensors among other information. The document can use a structure similar to the well-known resource specified in the CoAP standard. Information about CoAP resources can be found in K. Hartke, ed. “Observing Resources in CoAP”, draft-ietf-core-observe-04, Feb. 14, 2012, which is hereby incorporated herein by reference in its entirety. The following example includes a possible Semantic Data document in XML:

```
<?xml version=“1.0”?>
<sensors>
<sensor1>
    <name>Living room's temperature</name>
    <ip>123.123.123.123</ip>
    <sensorClass>Temperature</ sensorClass >
    <ivr>
        <option1>Request Temperature</option1>
    </ivr>
</sensor1>
<sensor2>
    <name>Main Door </name>
    <ip>123.123.123.124</ip>
    <sensorClass>Lock</ sensorClass >
    <ivr>
        <option1>Open door </option1>
        <option2>Close door </option2>
    </ivr>
</sensor2>
</sensors>
```

It can be seen in the above example that the gateway can interact with two types of sensors: one is a living room temperature sensor, and the other is a Main Door sensor. The exemplary semantic data document informs the respective IP addresses at which each of the sensors can be located on the (possibly constrained) network. The exemplary semantic data document also informs that the living room temperature sensor is in a class of sensors associated with temperature, and that one interaction that can be had with this sensor is to request a temperature reading.

The exemplary semantic data document further informs that the Main Door sensor is in a class related to locks, and that there are two possible interactions that can be performed with this sensor: one being a command to open the door (i.e., to unlock the door, and the other being a command to close the door (i.e., to lock the door).

An advantage of the invention is, as long as the semantic data is defined somewhere, that the voice interface can be used with any terminal enabled to communicate over a circuit switched communication network (e.g., by a normal phone call). A further advantage is that constrained devices, such as sensors and actuators, do not need to implement complex features such as voice or DTMF interfaces. An effect is that users are able to manage their constrained networks in an easy way, for example by simple IVR-user interfaces, using telephones. It is unnecessary to include complex solutions with computers or servers, although embodiments incorporating unconstrained devices are not excluded.

The invention has been described with reference to particular embodiments. However, it will be readily apparent to those skilled in the art that it is possible to embody the invention in specific forms other than those of the embodiment described above. Accordingly, the described embodiments are merely illustrative and should not be considered restrictive in any way. The scope of the invention is given by the appended claims, rather than the preceding description, and all variations and equivalents which fall within the range of the claims are intended to be embraced therein.

1. A method of operating a gateway apparatus to interact with a device that is connected to a network, the method comprising the gateway apparatus performing:
receiving voice or Dual-Tone Multi-Frequency (DTMF) signals from a user terminal via a circuit-switched connection;
using the received voice or DTMF signals in conjunction with a semantic data document to ascertain an interaction to be carried on with the device; and
generating and receiving signals via the network in accordance with the ascertained interaction.

2. The method of claim 1, comprising:
using one or more signals received from the device in conjunction with the semantic data document to generate a response to be sent to the user terminal via the circuit-switched connection.

3. The method of claim 2, comprising:
forming the response to be sent to the user terminal as a voice response.

4. The method of claim 1, wherein the semantic data document is an Extensible Markup Language (XML) document.

5. The method of claim 1, wherein the network is a constrained network.

6. The method of claim 1, comprising:
retrieving the semantic data document from a memory that is part of the gateway apparatus.

7. The method of claim 1, comprising:
retrieving the semantic data document from a memory that is external to the gateway apparatus.

8. The method of claim 7, wherein the memory that is external to the gateway apparatus is part of the device.

9. The method of claim 1, wherein the semantic data document separately defines permissible interactions for each one of a plurality of devices.

10. The method of claim 1, wherein the semantic data document defines an address of the device on the network.

11. A gateway apparatus for interacting with a device that is connected to a network, the gateway apparatus comprising:
circuitry configured to receive voice or Dual-Tone Multi-Frequency (DTMF) signals from a user terminal via a circuit-switched connection;
circuitry configured to use the received voice or DTMF signals in conjunction with a semantic data document to ascertain an interaction to be carried on with the device; and
circuitry configured to generate and receive signals via the network in accordance with the ascertained interaction.

12. The gateway apparatus of claim 11, comprising:
circuitry configured to use one or more signals received from the device in conjunction with the semantic data document to generate a response to be sent to the user terminal via the circuit-switched connection.

13. The gateway apparatus of claim 12, comprising:
circuitry configured to form the response to be sent to the user terminal as a voice response.

14. The gateway apparatus of claim 11, wherein the semantic data document is an Extensible Markup Language (XML) document.

15. The gateway apparatus of claim 11, wherein the network is a constrained network.

16. The gateway apparatus of claim 11, comprising:
a memory; and
circuitry configured to retrieve the semantic data document from the memory.

17. The gateway apparatus of claim 11, comprising:
circuitry configured to retrieve the semantic data document from a memory that is external to the gateway apparatus.

18. The gateway apparatus of claim 17, wherein the memory that is external to the gateway apparatus is part of the device.

19. The gateway apparatus of claim 11, wherein the semantic data document separately defines permissible interactions for each one of a plurality of devices.

20. The gateway apparatus of claim 11, wherein the semantic data document defines an address of the device on the network.
